(19) United States
(12) Patent Application Publication
(10) Pub. No.: US 2026/0212032 A1
(43) Pub. Date: Jul. 23, 2026

(54) SYSTEM, DEVICE, AND METHOD FOR HARDWARE-BASED HOST MANAGEMENT

(71) Applicant: Chipspirit Technologies Pvt Ltd, Bangalore (IN)

(72) Inventors: Mohan Kumar Jindal, Bangalore (IN); Srirama Chandra Murthy Pratapa, Bangalore (IN); Sumit Manoj Kavathekar, Bangalore (IN); Pratiksha Ishwar Jondhale, Bangalore (IN); Battula Sesha Sowjanya, Bangalore (IN); More Swapnil Sopanrao, Bangalore (IN); Vaghani Nikunj Mukeshbhai, Bangalore (IN); Ranam Sravani, Bangalore (IN); Palagani Jeevan Kumar Reddy, Bangalore (IN); Badham Hari Prasad, Bangalore (IN)

(73) Assignee: Chipspirit Technologies Pvt Ltd, Bangalore (IN)

(21) Appl. No.: 19/571,176

(22) Filed: Mar. 18, 2026

Related U.S. Application Data
(63) Continuation-in-part of application No. PCT/IN2024/051451, filed on Aug. 3, 2024.

(30) Foreign Application Priority Data
Oct. 12, 2023 (IN) 202341068789

(51) Int. Cl. G06F 21/60

(52) U.S. Cl. CPC G06F 21/606

(57) ABSTRACT

A host management device includes an initialization unit and a transaction unit. The initialization unit initializes a host system and one or more slave devices, and generates one or more endpoint commands. The transaction unit transfers a set of specifications of the slave device to the external data flow manager generates, based on the set of specifications of the slave device, one of a first signal and a second signal, and executes one of a transfer of the first data from the slave device to the external data flow manager when the first signal is generated and transfer of the second data from the external data flow manager to the slave device when the second signal is generated. The host management device is implemented using complete hardware-based digital designs such as FPGA, ASIC, or a combination thereof.

### CROSS-REFERENCE TO RELATED APPLICATIONS

This application is a continuation-in-part of PCT Application No. PCT/IN2024/051451, filed on Aug. 3, 2024, which claims priority to Indian Application No. 202341068789, filed Oct. 12, 2023, the complete disclosures of which, in their entireties, are herein incorporated by reference.

### TECHNICAL FIELD

The present disclosure relates generally to data communication. More particularly, the present disclosure relates to a system, a device, and a method for hardware-based host management.

### BACKGROUND

Systems with computational and storage capabilities may require data communication from slave devices. As the number and types of slave devices and the number of protocols over which slave devices communicate increases and changes, the importance to implement slave device controllers for management of communication between endpoints increases.

The challenges further increase when a data flow manager is required to receive data from a slave device that is coupled to a host system. The state of art systems that enable such communication are designed and deployed using hardware-software combination, and thus lack security being prone to digital cyber-attacks.

Thus, there is a need for a system, an apparatus, and a method capable of providing secure data transfer between slave devices and the data flow manager, which demands a need for improvised technical solution that overcomes the aforementioned problems.

### SUMMARY

In an aspect of the present disclosure, a host management device includes an initialization unit and a transaction unit coupled to each other. The initialization unit and the transaction unit are implemented using either of Field Programmable Gate Arrays (FPGAs), Application Specific Integrated circuits (ASICs), or a combination thereof. The initialization unit is configured to initialize a host system and one or more slave devices of an external unit for transfer of data between a slave device of the one or more slave devices that is coupled to the host system and an external data flow manager. The initialization unit is further configured to generate one or more endpoint commands to enable coupling between the slave device via the host system and the external data flow manager. The transaction unit is configured to transfer a set of specifications of the slave device that is coupled to the host system to the external data flow manager. The transaction unit is further configured to generate, based on the set of specifications of the slave device, one of a first signal and a second signal. Furthermore, the transaction unit is configured to execute one of a transfer of first data from the slave device to the external data flow manager when the first signal is generated and transfer of second data from the external data flow manager to the slave device when the second signal is generated.

In some aspects, to initialize the host system, the initialization unit is configured to initialize a set of internal registers of the host system. The initialization unit is further configured to generate a set of pointers for the set of internal registers. Furthermore, the initialization unit is configured to receive one or more interrupts from the host system based on the set of pointers. Furthermore, the initialization unit is configured to determine a state of each internal register of the set of internal registers based on the one or more interrupts. Furthermore, the initialization unit is configured to generate a flag for each internal register of the set of internal registers based on the state of each internal register.

In some aspects, to initialize the one or more slave device, the initialization unit is configured to determine a status of coupling of each slave device of the one or more slave devices with the host system. The initialization unit is further configured to update a set of coupling parameters associated with each slave device of the one or more slave devices based on the status of coupling. Furthermore, the initialization unit is configured to identify a slave device of the one or more slave devices that is coupled to the host system based on a status of coupling of each slave device of the one or more slave devices.

In some aspects of the present disclosure, prior to the transfer the set of specifications of the slave device to the external data flow manager, the transaction unit is configured to receive a device enquiry request from the external data flow manager. The transaction unit is further configured to generate a request signal for transmission of the device enquiry request to the slave device via the host system. Furthermore, the transaction unit is configured to transmit the request signal to the host system. Furthermore, the transaction unit is configured to receive the set of specifications of the slave device from the host system in response to the request signal. Furthermore, the transaction unit is configured to validate the set of specifications. Upon validation of the set of specification, the transaction unit is configured to store the set of specifications of the slave device into a temporary memory.

In some aspects, prior to the generation of the first signal, the transaction unit is configured to receive the first data from the slave device and store the first data in the temporary memory. The transaction unit is further configured to determine, a first set of values for a set of parameters from the first data. Furthermore, the transaction unit is configured to determine a validity of the first data based on a comparison of the first set of values with a predefined set of values of the set of parameters. Furthermore, the transaction unit is further configured to enable the generation of the first signal, when the validity of the first data is “true”.

In some aspects, prior to the generation of the second signal, the transaction unit is configured to receive the second data from the external data flow manager and store the second data in the temporary memory. The transaction unit is further configured to determine a second set of values for the set of parameters from the second data. Furthermore, the transaction unit is configured to determine a validity of the second data based on a comparison of the second set of values with the predefined set of values of the set of parameters. Furthermore, the transaction unit is configured to enable the generation of the second signal, when the validity of the second data is “true”.

In another aspect of the present disclosure, initializing, by way of an initialization unit of a host management device, a host system and one or more slave devices of an external unit for transfer of data between a slave device of the one or more slave devices that is coupled to the host system and an external data flow manager. The method further includes generating, by way of an initialization unit, one or more endpoint commands to enable coupling between the slave device of the one or more slave devices and the external data flow manager (via the host system). Furthermore, the method includes transferring, by way of a transaction unit of the host management device, a set of specifications of the slave device that is coupled to the host system to the external data flow manager. Furthermore, the method includes generating, by way of the transaction unit, based on the set of specifications of the slave device, one of a first signal and a second signal. Furthermore, the method includes executing, by way of the transaction unit, one of a transfer of first data from the slave device to the external data flow manager when the first signal is generated and transfer of second data from the external data flow manager to the slave device when the second signal is generated. The initialization unit and the transaction unit are implemented using either of Field Programmable Gate Arrays (FPGAs), Application Specific Integrated circuits (ASICs), or a combination thereof.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a block diagram of a system for hardware-based host management, in accordance with an exemplary aspect of the present disclosure; and

FIG. 2 illustrates a flow chart of a method for the hardware-based host management, in accordance with an exemplary aspect of the present disclosure.

To facilitate understanding, like reference numerals have been used, where possible, to designate like elements common to the figures.

### DETAILED DESCRIPTION

Various aspect of the present disclosure provides a system, a device, and a method for hardware-based host management. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element is referred to as being “on,” “connected to,” or “coupled to” another element, it can be directly on, connected to, or coupled to the other element or intervening elements that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the claimed subject matter might also be embodied in other ways, to include different features or combinations of features similar to the ones described in this document, in conjunction with other technologies. Generally, the various aspects including the example aspects relate to the system and the method for hardware-based host management for transfer of data between slave device and an external data flow manager.

As mentioned, there is a need for a system, a device, and a method capable of providing secure data transfer between slave devices and the data flow manager. The present aspects, therefore: provides the system, the device, and the method for hardware-based host management that provides secure data transfer between slave devices and the external data flow manager to overcome the aforementioned problems.

The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practiced and to further enable those of skill in the art to practice the aspects herein. Accordingly, the examples should not be construed as limiting the scope of the aspects herein.

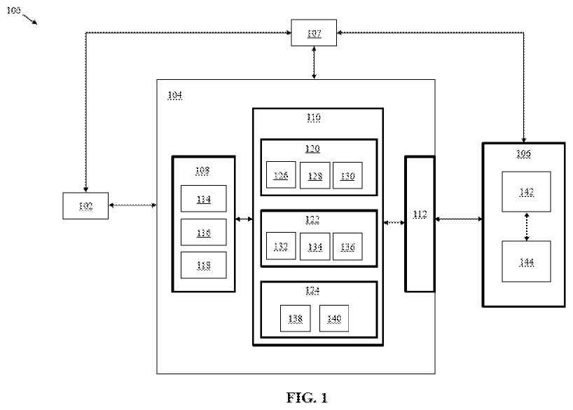

FIG. 1 illustrates a block diagram of the system 100 for hardware-based host management to provide secure data transfer between one or more slave devices and the data flow manager, in accordance with an exemplary aspect of the present disclosure. The system 100 may include an external data flow manager 102, a host management device 104, an external unit 106, and a temporary memory 107 that may be coupled to each other.

The system 100 can be implemented using a hardware-based digital design circuitry (such as Field Programmable Gate Arrays (FPGAs), Application Specific Integrated Circuits (ASICs), a combination of FPGAs and ASICs, and the like, and does not include any software-derived microcontroller and or framework for operation. Specifically, the external data flow manager 102, the host management device 104, the external unit 106, and the temporary memory 107 may be implemented using a digital design hardware (such as a Field Programmable Gate Array (FPGA), an Application Specific Integrated Circuits (ASICs), a combination of FPGAs and ASICs, and the like).

The external data flow manager 102 may be configured to receive first data from the external unit 106. The external data flow manager 102 may further be configured to send second data to the external unit 106. Furthermore, the external data flow manager 102 may be configured to generate a device enquiry request for enquiry of one or more specifications of one or more components of the external unit 106. Specifically, the external data flow manager 102 may be configured to transmit (or send) the device enquiry request to the one or more components of the external unit 106 via the host management device 104. Furthermore, the external data flow manager 102 may be configured to receive a set of specifications of the one or more components of the external unit 106 from the temporary memory 107 based on one or more instructions by the host management device 104. In some aspects of the present disclosure, the external data flow manager 102 may be configured to execute the transfer of the first and second data parallelly to and from the temporary memory 107 between a slave device of the one or more slave devices 144 and the external data flow manager 102. The external data flow manager 102 may further generate an acknowledgement signal upon a successful transfer of the first data or the second data.

The host management device 104 may include an initialization unit 108, a transaction unit 110 and a management interface 112. In some aspects of the present disclosure, the initialization unit 108 may include a host initialization unit 114, a device initialization unit 116, and an endpoint command unit 118. In some aspects of the present disclosure, the transaction unit 110 may include a specification agent unit 120, an inlet agent unit 122, and an outlet agent unit 124. Specifically, the specification agent unit 120 may include first through third specification agents 126-130, the inlet agent unit 122 may include first through third inlet agents 132-136, and the outlet agent unit 124 may include first and second outlet agents 138 and 140, respectively. Each component of the host management device 104 (as mentioned hereinabove) may be implemented using digital design hardware such as Field Programmable Gate Array (FPGAs), Application Specific Integrated Circuits (ASICs), a combination of FPGAs and ASICs, and the like.

The external unit 106 may include a host system 142 and the one or more slave devices 144 such that the one or more slave devices 144 may be coupled to the host system 142. In some aspects of the present disclosure, the host system 142 may be configured to control one or more operations of at least one slave device of the one or more slave devices 144. The management interface 112 may be configured to couple the one or more slave devices 144 to the initialization unit 108, the transaction unit 110, and the external data flow manager 102. Specifically, the management interface 112 may be coupled to the host system 142 such that the management interface 112 may couple the one or more slave devices 144 to the initialization unit 108, the transaction unit 110, and the external data flow manager 102 via the host system 142.

The initialization unit 108 may be configured to initialize the host system 142 and the one or more slave devices 144 for transfer of data from a slave device of the one or more slave devices 144 that may be coupled to the host system 142 to the external data flow manager 102. The initialization unit 108 may further be configured to generate one or more endpoint commands to enable coupling between the slave device of the one or more slave devices 144 and the external data flow manager 102 via the host system 142. Specifically, the host initialization unit 114 may be configured to initialize the host system 142, the device initialization unit 116 may be configured to initialize the one or more slave devices 144, and the endpoint command unit 118 may be configured to generate the one or more endpoint commands host system to enable coupling between the slave device of the one or more slave devices 144 (via the host system 142) and the external data flow manager 102.

In some aspects of the present disclosure, to initialize the host system 142, the host initialization unit 114 may be configured to initialize a set of internal registers associated with the host system 114. The host initialization unit 114 may further be configured to generate a set of pointers for the set of internal registers. Furthermore, the host initialization unit 114 may be configured to receive one or more interrupts from the host system 142 based on the set of pointers. Furthermore, the host initialization unit 114 may be configured to determine a state of each internal register of the set of internal registers based on the one or more interrupts. Furthermore, the host initialization unit 114 may be configured to generate a flag for each internal register of the set of internal registers based on the state of each internal register such that the flag for each internal register may depict (or represent) the state of each internal register of the set of internal registers.

The device initialization unit 116 may be configured to initialize the one or more slave devices 144. In some aspects of the present disclosure, the device initialization unit 116 may be configured to initialize the one or more slave devices 144 via the host system 142. In some aspects of the present disclosure, to initialize the one or more slave devices 144, the device initialization unit 116 may be configured to determine a status of coupling of each slave device of the one or more slave devices 144 with the host system 142. The device initialization unit 116 may further be configured to update a set of coupling parameters associated with each slave device of the one or more slave devices 144 based on the status of coupling of each slave device of the one or more slave devices 144 with the host system 142. Furthermore, the device initialization unit 116 may be configured to identify a slave device of the one or more slave devices 144 that may be coupled to the host system 142 based on the status of coupling of each slave device of the one or more slave devices 144.

The endpoint command unit 118 may be configured to generate the one or more endpoint commands to enable coupling between the slave device of the one or more slave devices 144 (via the host system 142) and the external data flow manager 102. Preferably, upon the identification of the slave device of the one or more slave devices 144 that is coupled to the host system 142, the endpoint command unit 118 may be configured to generate one or more endpoint commands to enable a coupling of the slave device of the one or more slave devices 144 with the external data flow manager 102 via the host system 142.

Upon the coupling of the slave device of the one or more slave devices 144 with the external data flow manager 102 via the host system 142, the specification agent unit 120 may be configured to transfer a set of specifications of the slave device to the external data flow manager 102. In some aspects of the present disclosure, to the transfer the set of specifications of the slave device of the one or more slave devices 144 to the external data flow manager 102, the specification agent unit 120 may be configured to receive a device enquiry request from the external data flow manager 102. The specification agent unit 120 may further be configured to generate a request signal for transmission of the device enquiry request to the slave device via the host system 142. Furthermore, the specification agent unit 120 may be configured to transmit the request signal to the host system 142. Specifically, the first specification agent 126 may be configured to receive the device enquiry request from the external data flow manager, generate the request signal for transmission of the device enquiry request to the slave device, and transmit the request signal to the host system 142.

The specification agent unit 120 may further be configured to receive the set of specifications (as a plurality of specification carrier blocks) of the slave device from the host system 142 in response to the request signal. Furthermore, the specification agent unit 120 may be configured to determine a validity of the set of specifications of the slave device based on a comparison of the set of specifications with a predefined set of specifications. Upon validation of the set of specifications of the slave device, the specification agent unit 120 may be configured to store the set of specifications of the slave device into the temporary memory 107. Specifically, the second specification agent 128 may be configured to receive the set of specifications of the slave device from the host system 142, determine the validity of the set of specifications, and store the set of specifications of the slave device into the temporary memory 107 upon validation of the set of specifications of the slave device.

Furthermore, the specification agent unit 120 may be configured to retrieve the set of specifications of the slave device from the temporary memory 107 and provide the set of specifications of the slave device to the external data flow manager 102 as and when required by the external data flow manager 102. Specifically, the third specification agent 130 may be configured to retrieve the set of specifications of the slave device from the temporary memory 107 and provide the set of specifications of the slave device to the external data flow manager 102.

Upon the reception of the set of specifications of the slave device by the external data flow manager 102, the transaction unit 110 may be configured to generate, based on the set of specifications of the slave device, one of a first signal and a second signal. In some aspects of the present disclosure, to transfer first data from the slave device to the external data manager 102, the inlet agent unit 122 of the transaction unit 110 may be configured to receive the first data from the slave device. The inlet agent unit 122 may further be configured to determine a first set of values for a set of parameters from the first data. Furthermore, the inlet agent unit 122 may further be configured to store the first data and the first set of values for the set of parameters in the temporary memory 107. Specifically, the first inlet agent 132 may be configured to receive the first data from the slave device, determine the first set of values for the set of parameters from the first data, and store the first data and the first set of values for the set of parameters in the temporary memory 107.

Upon storage of the first data and the first set of values for the set of parameters in the temporary memory 107, the inlet agent unit 122 may be configured to determine a validity of the first data based on a comparison of the first set of values with a predefined set of values of the set of parameters. Specifically, the second inlet agent 134 may be configured to determine the validity of the first data based on the comparison of the first set of values with the predefined set of values of the set of parameters.

Upon validation of the first data (i.e., when the validity of the first data is “true”), the inlet agent unit 122 may be configured to enable the host system 142 to generate a first signal (that may be an acknowledgement signal) such that the first signal enables the transfer of the first data from the temporary memory 107 to the external data flow manage 102. Specifically, the third inlet agent 136 may be configured to generate the first signal upon validation of the first data, and may enables the transfer of the first data from the temporary memory 107 to the external data flow manage 102. As will be appreciated by a person of ordinary skill in the art, the first data originates from the slave device coupled to the host system 142, and thus the inlet agent unit 122 may enable transfer of the first data from the slave device to the external data flow manager 102.

In some other aspects of the present disclosure, for transfer of second data from the external data flow manager 102 to the slave device of the one or more slave devices 144 that is coupled to the host system 142, the transaction unit 110 by way of the outlet agent unit 124 may be configured to receive the second data from the external data flow manager 102. The outlet agent unit 124 may further be configured to determine, a second set of values for the set of parameters from the second data. The outlet agent unit 124 may further be configured to store the second data and the second set of values for the set of parameters in the temporary memory 107. Specifically, the first outlet agent 138 of the outlet agent unit 124 may be configured to receive the second data from the external data flow manager 102, determine the second set of values for the set of parameters, and store the second data and the second set of values of the set of parameters into the temporary memory 107.

Upon storage of the second data and the second set of values for the set of parameters into the temporary memory 107, the outlet agent unit 124 may be configured to determine a validity of the second data based on a comparison of the second set of values with the predefined set of values of the set of parameters. Upon validation of the second data (i.e., when the validity of the second data is “true”), the outlet agent unit 124 may be configured to generate a second signal (that may be an acknowledgement signal) such that the second signal enables the transfer of the second data from the temporary memory 107 to the slave device via the host system 142. Specifically, the first outlet agent 138 may be configured to enables the transfer of the second data from the temporary memory 107 to the slave device via the host system 142. As will be appreciated by a person of ordinary skill in the art, the second data originates from the external data flow manager 102, and thus the outlet agent unit 124 may enable transfer of the second data from the external data flow manager 102 to the slave device of the one or more slave devices 144 that is coupled to the host system 142.

In operation, the host management device 104, by way of the initialization unit 108 may be configured to initialize the host system 142 and the one or more slave devices 144 of the external unit 106 for transfer of one of the first data and the second data between the slave device of the one or more slave devices 144 and the external data flow manager 102. The host management device 104, by way of the initialization unit 108 may further be configured to generate the one or more endpoint commands to enable coupling between the external unit 106 (specifically the slave device) and the external data flow manager 102 via the host system 142. Furthermore, the host management device 104, by way of the transaction unit 110 may be configured to transfer the set of specifications of the slave device that is coupled to the host system 142 to the external data flow manager 102. Upon reception of the set of specifications, the host management device 104, by way of the transaction unit 110 may be configured to generate, based on the set of specifications of the slave device, one of the first signal and the second signal such that the first signal enables transfer of the first data between the slave device and the external data flow manager 102 and the second signal enables transfer of the second data between the external data flow manager 102 to the slave device of the one or more slave devices 144 that is coupled to the host system 142.

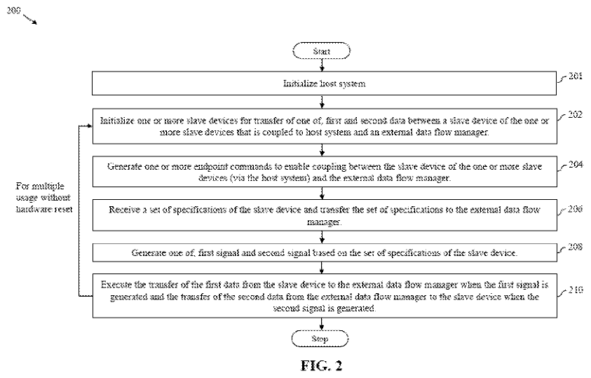

FIG. 2 illustrates a flow chart of a method 200 for the hardware-based host management, in accordance with an exemplary aspect of the present disclosure.

At step 201, the host management device 104 may initialize the host system 142.

At step 202, the host management device 104 may initialize the one or more slave devices 144 for transfer of one of the first and second data between the slave device of the one or more slave devices 144 that is coupled to the host system 142 and the external data flow manager 102.

In some aspects of the present disclosure, for initialization of the host system 142, the host management device 104 may initialize the set of internal registers of the host system 142, generate the set of pointers for the set of internal registers, receive one or more interrupts from the host system 142 based on the set of pointers, determine the state of each internal register of the set of internal registers based on the one or more interrupts, and generate the flag for each internal register of the set of internal registers based on the state of each internal register.

In some aspects of the present disclosure, for initialization of the one or more slave devices 144, the host management device 104 may determine the status of coupling of each slave device of the one or more slave devices 144 with the host system 142, update the set of coupling parameters associated with each slave device of the one or more slave devices 144 based on the status of coupling of each slave device, and identify the slave device of the one or more slave devices 144 that is coupled to the host system 142 based on the status of coupling of each slave device of the one or more slave devices.

At step 204, the host management device 104 may generate the one or more endpoint commands to enable coupling between the slave device of the one or more slave devices 144 (via the host system 142) and the external data flow manager 102.

At step 206, upon coupling between the host system 142 and the external data flow manager 102, the host management device 104 may receive the set of specifications of the slave device and transfer the set of specifications to the external data flow manager 102.

In some aspects of the present disclosure, at step 206, the host management device 104 may receive the device enquiry request from the external data flow manager 102. The host management device 104 may further generate the request signal for transmission of the device enquiry request to the slave device via the host system 142. Furthermore, the host management device 104 may transmit the request signal to the host system 142. Furthermore, the host management device 104 may receive the set of specifications of the slave device from the host system 142 in response to the request signal. Furthermore, the host management device 104 may determine the validity of the set of specifications of the slave device based on the comparison of the set of specifications with the predefined set of specifications. Furthermore, the host management device 142 may store the set of specifications of the slave device into the temporary memory 107, when the validity of the set of specifications of the slave device is “true”.

At step 208, the host management device 104 may generate one of the first signal and the second signal based on the set of specifications of the slave device.

In some aspects of the present disclosure, for generation of the first signal, the host management device 104 may receive the first data from the slave device and store the first data in the temporary memory 107. The host management device 104 may further determine the first set of values for the set of parameters from the first data. Furthermore, the host management device 104 may determine the validity of the first data based on the comparison of the first set of values with the predefined set of values of the set of parameters. Furthermore, the host management device 104 may enable the generation of the first signal, when the validity of the first data is “true”.

In some aspects of the present disclosure, for generation of the second signal, the host management device 104 may receive the second data from the external data flow manager 102 and store the second data in the temporary memory 107. The host management device 104 may further determine the second set of values for the set of parameters from the second data. Furthermore, the host management device 104 may be configured to determine the validity of the second data based on the comparison of the second set of values with the predefined set of values of the set of parameters. Furthermore, the host management device 104 may be configured to enable the generation of the second signal, when the validity of the second data is “true”.

At step 210, the host management device 104 may execute the transfer of the first data from the slave device to the external data flow manager 102 when the first signal is generated and the transfer of the second data from the external data flow manager 102 to the slave device when the second signal is generated.

In some aspects of the present disclosure, the host management device 104 may execute steps 202 to 210 for multiple transactions of the first data and the second data between the slave device of the one or more slave devices 144 and the external data flow manager 102 without a requirement of a hardware reset of the system 100.

As mentioned, there is a need for a system, an apparatus, and a method capable of providing secure data transfer between one or more slave devices and the data flow manager. The present aspects, therefore: provides the system 100, the host management device 104, and the method 200 that provides secure data transfer between one or more slave devices and the external data flow manager 102 to overcome the aforementioned problems. Specifically, the various components of the host management device 104 are implemented only on hardware and does not use any software for data transfer between the one or more slave devices 144 and the external data flow manager 102. As the various components of the host management device 104 are implemented at least one of a Field Programmable Gate Array (FPGA), Application Specific Integrated Circuits (ASICs), or a combination thereof (i.e., hardware implemented digital circuitry), the host management device 104 is nearly impossible to be hacked and thus provides an extensive data security of data transfer. The hardware implementation of the protocols that provide the overall functionality of the system 100 (as discussed hereinabove through steps 201 to 210 of the method 200) further enhances the efficiency and reduces latency of data transfer between the one or more slave devices 144 and the external data flow manager 102.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

We claim:

1. A host management device comprising:
an initialization unit configured to (i) initialize a host system and one or more slave devices of an external unit for transfer of one of first and second data between a slave device of the one or more slave devices that is coupled to the host system and an external data flow manager, and (ii) generate one or more endpoint commands to enable coupling between the slave device and the external data flow manager; and
a transaction unit that is coupled to the initialization unit, and configured to (i) transfer a set of specifications of the slave device that is coupled to the host system to the external data flow manager, (ii) generate, based on the set of specifications of the slave device, one of a first signal and a second signal, and (iii) execute one of a transfer of the first data from the slave device to the external data flow manager when the first signal is generated and transfer of the second data from the external data flow manager to the slave device when the second signal is generated,
wherein the initialization unit and the transaction unit are implemented using either of Field Programmable Gate Arrays (FPGAs), Application Specific Integrated circuits (ASICs), or a combination thereof.

2. The host management device as claimed in claim 1, wherein to initialize the host system, the initialization unit is configured to (i) initialize a set of internal registers of the host system, (ii) generate a set of pointers for the set of internal registers, (iii) receive one or more interrupts from the host system based on the set of pointers, (iv) determine a state of each internal register of the set of internal registers based on the one or more interrupts, and (v) generate a flag for each internal register of the set of internal registers based on the state of each internal register.

3. The host management device as claimed in claim 1, wherein to initialize the one or more slave devices, the initialization unit is configured to (i) determine a status of coupling of each slave device of the one or more slave devices with the host system, (ii) update a set of coupling parameters associated with each slave device of the one or more slave devices based on the status of coupling, and (iii) identify a slave device of the one or more slave devices that is coupled to the host system based on the status of coupling of each slave device of the one or more slave devices.

4. The host management device as claimed in claim 1, wherein prior to the transfer the set of specifications of the slave device to the external data flow manager, the transaction unit is configured to (i) receive a device enquiry request from the external data flow manager, (ii) generate a request signal for transmission of the device enquiry request to the slave device via the host system, (iii) transmit the request signal to the host system, (iv) receive the set of specifications of the slave device from the host system in response to the request signal, (v) determine a validity of the set of specifications of the slave device based on a comparison of the set of specifications with a predefined set of specifications, and (vi) store the set of specifications of the slave device into a temporary memory, when the validity of the set of specifications of the slave device is “true”.

5. The host management device as claimed in claim 1, wherein prior to the generation of the first signal, the transaction unit is configured to (i) receive the first data from the slave device and store the first data in the temporary memory, (ii) determine, a first set of values for a set of parameters from the first data, (iii) determine a validity of the first data based on a comparison of the first set of values with a predefined set of values of the set of parameters, and (iv) generate a first signal, when the validity of the data is “true”.

6. The host management device as claimed in claim 1, wherein prior to the generation of the second signal, the transaction unit is configured to (i) receive the second data from the external data flow manager and store the second data in the temporary memory, (ii) determine, a second set of values for the set of parameters from the second data, (iii) determine a validity of the second data based on a comparison of the second set of values with the predefined set of values of the set of parameters, and (iv) generate a second signal, when the validity of the second data is “true”.

7. A method comprising:
initializing, by way of an initialization unit of a host management device, a host system and one or more slave devices of an external unit for transfer of one of first and second data between a slave device of the one or more slave devices that is coupled to the host system and an external data flow manager;
generating, by way of an initialization unit, one or more endpoint commands to enable coupling between the slave device and the external data flow manager;
transferring, by way of a transaction unit of the host management device, a set of specifications of the slave device that is coupled to the host system to the external data flow manager;
generating, by way of the transaction unit, based on the set of specifications of the slave device, one of a first signal and a second signal; and
executing, by way of the transaction unit, one of a transfer of the first data from the slave device to the external data flow manager when the first signal is generated and transfer of the second data from the external data flow manager to the slave device when the second signal is generated,
wherein the initialization unit and the transaction unit are implemented using either of Field Programmable Gate Arrays (FPGAs), Application Specific Integrated circuits (ASICs), or a combination thereof.

8. The method as claimed in claim 7, wherein for initialization of the host system, the method comprising (i) initializing, by way of the initialization unit, a set of internal registers of the host system, (ii) generating, by way of the initialization unit, a set of pointers for the set of internal registers, (iii) receiving, by way of the initialization unit, one or more interrupts from the host system based on the set of pointers, (iv) determining, by way of the initialization unit, a state of each internal register of the set of internal registers based on the one or more interrupts, and (v) generating, by way of the initialization unit, a flag for each internal register of the set of internal registers based on the state of each internal register.

9. The method as claimed in claim 7, wherein to initialize the one or more slave devices, the method comprising (i) determining, by way of the initialization unit, a status of coupling of each slave device of the one or more slave devices with the host system, (ii) updating, by way of the initialization unit, a set of coupling parameters associated with each slave device of the one or more slave devices based on the status of coupling, and (iii) identifying, by way of the initialization unit, a slave device of the one or more slave devices that is coupled to the host system based on the status of coupling of each slave device of the one or more slave devices.

10. The method as claimed in claim 7, wherein prior to the transfer the set of specifications of the slave device to the external data flow manager, the method comprising (i) receiving, by way of the transaction unit, a device enquiry request from the external data flow manager, (ii) generating, by way of the transaction unit, a request signal for transmission of the device enquiry request to the slave device via the host system, (iii) transmitting, by way of the transaction unit, the request signal to the host system, (iv) receiving, by way of the transaction unit, the set of specifications of the slave device from the host system in response to the request signal, (v) determining, by way of the transaction unit, a validity of the set of specifications of the slave device based on a comparison of the set of specifications with a predefined set of specifications, and (vi) storing, by way of the transaction unit, the set of specifications of the slave device into a temporary memory, when the validity of the set of specifications of the slave device is “true”.

11. The method as claimed in claim 7, wherein prior to the generation of the first signal, the method comprising (i) receiving, by way of the transaction unit, the first data from the slave device and store the first data in the temporary memory, (ii) determining, by way of the transaction unit, a first set of values for a set of parameters from the first data, (iii) determining, by way of the transaction unit, a validity of the first data based on a comparison of the first set of values with a predefined set of values of the set of parameters, and (iv) enabling, by way of the transaction unit, the generation of the first signal, when the validity of the first data is “true”.

12. The method as claimed in claim 7, wherein prior to the generation of the second signal, the method comprising (i) receiving, by way of the transaction unit, the second data from the external data flow manager and store the second data in the temporary memory, (ii) determining, by way of the transaction unit, a second set of values for the set of parameters from the second data, (iii) determining, by way of the transaction unit, a validity of the second data based on a comparison of the second set of values with the predefined set of values of the set of parameters, and (iv) enabling, by way of the transaction unit, the generation of the second signal, when the validity of the second data is “true”.
